(19) United States
(12) Patent Application Publication
(10) Pub. No.: US 2024/0409735 A1
(43) Pub. Date: Dec. 12, 2024

(54) CORROSION INHIBITOR INFUSED INTO AN ELASTOMERIC RUBBER

(71) Applicant: Ship 2 Shore Inc., Virginia Beach, VA (US)

(72) Inventors: Erik Ernest Bergvinson, Whistler (CA); Colin James Evans, Bacchus Marsh (AU)

(73) Assignee: Ship 2 Shore Inc., Virginia Beach, VA (US)

(21) Appl. No.: 18/738,511

(22) Filed: Jun. 10, 2024

Related U.S. Application Data
(60) Provisional application No. 63/472,194, filed on Jun. 9, 2023.

(51) Int. Cl. C08L 23/16; C08K 3/22; C08K 5/01; C08K 5/3445; C08K 5/42; C08K 9/12; C08K 13/06; C09K 3/10

(52) U.S. Cl. CPC C08L 23/16; C08K 13/06; C09K 3/10; C08K 2003/2206; C08K 5/01; C08K 5/3445; C08K 5/42; C08K 9/12; C08L 2201/08; C08L 2205/025; C08L 2205/03; C08L 2205/06; C08L 2207/322; C09K 2200/0476; C09K 2200/0488; C09K 2200/0642; C09K 2200/069

(57) ABSTRACT

In an aspect, the disclosure relates to a composition comprising an elastomeric substance and at least one corrosion inhibitor, preferably the at least one corrosion inhibitor is a corrosion inhibitor blend. The disclosure also relates to an elastomeric material, such as a gasket, comprising a corrosion inhibitor blend having at least one corrosion inhibitor, and an elastomeric substance. Preferably the elastomeric material prevents corrosion of a metal surface to which it makes contact. The disclosure also relates to methods of making the elastomeric material, as well as methods of preventing corrosion comprising placing the elastomeric material in contact with a metal surface, or between two or more metal surfaces or joints.

### FIELD OF THE INVENTION

The disclosure herein relates to an elastomeric material comprising an elastomeric substance and a corrosion inhibitor blend. The corrosion inhibitor blend is comprised of one or more corrosion inhibitors such that the elastomeric material includes the properties of the elastomeric substance and the corrosion inhibition blend. The disclosure also relates to gaskets and other elastomeric materials for use as extruded compression seals, dielectric galvanic isolation barrier materials, and scupper lips as examples, formed from the elastomeric material comprising the elastomeric substance and the corrosion inhibitor blend such that the exemplary gasket or the like, is a corrosion preventive gasket. The disclosure further relates to a method of making the elastomeric material comprising the elastomeric substance and the corrosion inhibitor blend, as well as a method of preventing corrosion by placing a corrosion preventive elastomeric material on a metal surface or between two or more metal surfaces.

### BACKGROUND OF THE INVENTION

Corrosion is a process that involves the deterioration of metals. It is typically the result of an electrochemical reaction that can occur when acidic substances or high salt solutions come in contact with metals while in the presence of oxygen, such that corrosion of the metal begins to occur. Moisture in the air can also react with oxygen and electrons on the surface of the metal leading to corrosion. Over time, this corrosion leads to weakened structures, damage to mechanical parts, poor appearance, the development of friction hampering the movement of metal components against one another, and other impairments such as poor conduction of electricity and weakened magnetic attraction.

Corrosion can happen at any rate, depending in part on the environment the metal is in. For example, atmospheric corrosion can be greater under conditions of increased humidity, higher moisture, and/or exposure to water. Adding to the rate of corrosion from water exposure is salt, for example in seawater or salt spray. While in the presence of oxygen the exposure of metals to external environmental factors, including but not limited to moisture, wind, water, acid rain, corrosive chemicals, and certain biological substances, can cause oxidation and eventually corrosion of the metal.

In some settings, corrosion can be minimized by providing a climate-controlled facility. However, metals are used in numerous applications, many of which cannot be performed in a climate-controlled setting. In such instances, corrosion can potentially be treated or repaired, although the results may not be adequate or easily performed. Therefore, other means to minimize corrosion are performed, such as the use of products to cover the metal in an attempt to protect it. Examples of these coverings may include painting, galvanizing, or coating a metal surface (sacrificial or protective coatings). Alternatively, manipulating the environment, such as by re-directing water flow may be of use.

Metals can also corrode where two metals components meet. The corrosion of the metal can result in changes to its shape, structure, and function, which can affect the way two or more metal surfaces interact and the function of the metal itself. Such changes may result in faulty or leaking areas, and may further hamper efforts to replace these corroded metal parts.

Gaskets are commonly used to fill the space between two or more such mating surfaces, generally to prevent leakage or provide a better fit. Gaskets are typically made of a deformable material that can create and maintain a seal of a mechanical assembly. These seals are often between mating surfaces or machine parts having less than perfect mating surfaces.

Gaskets are typically made from materials having at least some ability to deform while tightly filling the space they occupy. Certain applications also require that a gasket have the ability to withstand high compressive loads. Gaskets come in a variety of different designs and shapes, including but not limited to sheets gaskets, solid material gaskets, flange gaskets, and ring-type joint gaskets.

Given the potential cost and safety implications of faulty or leaking metal parts where gaskets are used, it is critical that the correct gasket material is selected to fit the needs of the application. A gasket able to isolate any electrical potential between metals and reduce the electrolyte-induced electron flow effect between them may also help to reduce corrosion of metals in which the gasket is interposed, thereby preventing or decreasing the corrosion of the metals. Such a gasket would also have to maintain a compressible polymer rheology and the strength of the elastomer, protect against metal to metal contact, and provide a void and holiday free pressure positive compression sealing having durability.

Another example of corrosion formation is the scupper on a boat. This opening in the side walls of a ship or vessel allows water to drain instead of pooling within the bulwark or gunwales of a ship or vessel. Similar use of a scupper can be within the curbing or walls of a building. If the vessel or building has metal parts in the path of such water drainage, whether from the scupper itself or other building parts, this flow of water can cause the rust streaks commonly found on the sides of ships. Having the ability to minimize corrosion in the areas around a scupper for example would be of great use.

Current attempts at preventing corrosion inhibition are not able to sufficiently prevent or manage levels of corrosion. Whether in the form of a liquid, a paint, a spray, a galvanizing spray, a rubber seal, a rubber seal with oils, and other related items, the current products and methods available do not offer protection against continuous corrosion.

There exists a need in the field of metal parts to reduce corrosion upon exposure of such metal parts to corrosion conditions, such as oxygen in a high moisture or high salt environment. A corrosion inhibitor that is better able to latch onto a metal surface without being displaced would be of great benefit to protecting the metal from corrosion and protecting the metal from corrosion in an environment where continuous exposure to such corrosion inducing elements exists.

### SUMMARY OF THE INVENTION

In an aspect, the invention relates to an elastomeric material comprising, consisting essentially of, or consisting of an elastomeric substance and a corrosion inhibitor blend having one or more corrosion inhibitors. The corrosion inhibitor blend can polar bond with a metal, such that the elastomeric material may prevent corrosion of the metal to which is makes contact. The components of the elastomeric material, including at least the corrosion inhibitor blend, are also uniformly distributed throughout the elastomeric material. The one or more corrosion inhibitors is selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate, and is able to polar bond with a metal thereby preventing corrosion of the metal to which it makes contact. The elastomeric substance comprises at least one of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams. The elastomeric material may further comprise any one or more of reinforcing fillers, extending fillers, process oils, curatives and other specially formulated corrosion inhibitor additives.

In an aspect, the invention relates to a method for making an elastomeric material comprising an elastomeric substance and a corrosion inhibitor blend, the method comprising, consisting essentially of, or consisting of mixing one or more corrosion inhibitors to form a corrosion inhibitor blend, compounding the elastomeric substance into an uncured paste consistency, infusing the corrosion inhibitor blend with the elastomeric substance during compounding until a composited material is formed, and curing of the composited material to form the elastomeric material. The mixing of the corrosion inhibitor blend and infusing thereof with the elastomeric substance may further include a specific mixing sequence and infusing sequence. The compounding may further include adding additives. The method may further include calendaring during the compounding, whereby the calendaring facilitates smoothing and compression of all ingredients of the material and preferably eliminates any dry/unwetted zones to eliminate uncurable areas of the composited material infused with the corrosion inhibitor blend. The method may also comprise a heated mixing, shaping, extruding, molding, curing, or vulcanization.

In an aspect, the invention relates to a method of preventing corrosion of a metal comprising placing an elastomeric material in contact with the metal, whereby the elastomeric material comprises an elastomeric substance and a corrosion inhibitor blend. The corrosion inhibitor blend comprises one or more corrosion inhibitors. The corrosion inhibitor blend can bleed out from the elastomeric material and polar bond with the metal. The elastomeric material may prevent corrosion of a metal surface to which it makes contact. The elastomeric material may be a gasket or a scupper lip.

### BRIEF DESCRIPTION OF DRAWINGS

The following detailed description of the embodiments of the present invention will be better understood when read in conjunction with the appended drawings. It is understood, however, that the invention is not limited to the precise arrangements shown. In the drawings:

FIG. 1 shows a cross-sectional view of a material comprising ethylene propylene diene monomer (EPDM) in the absence of a corrosion inhibitor blend.

FIG. 2 shows a cross-sectional view of a material comprising ethylene propylene diene monomer (EPDM) having uniform dispersion of corrosion inhibitor blend throughout the thickness of the EPDM.

FIG. 3 shows a cross-sectional view of a material comprising ethylene propylene diene monomer (EPDM) having uniform dispersion of corrosion inhibitor blend throughout the thickness of the EPDM, the material being under compression and in total contact with a metal surface.

FIG. 4 shows a perspective view of a material in the form of a scupper lip, the material including an elastomeric substance and a corrosion inhibitor blend.

FIG. 5 shows a method of formation of an ethylene propylene diene monomer (EPDM) compound infused with corrosion inhibitor blend.

FIG. 6A shows a new flange assembly.

FIG. 6B shows the flange assembly with an EPDM based gasket material comprising a corrosion inhibitor blend.

FIG. 6C shows the assembled flange with gasket material immersed in 32% hydrochloric acid.

FIG. 6D shows the assembled flange with gasket material immersed in a hypersaline solution.

FIG. 6E shows the assembled flange with gasket material after 24 hours of immersion in the 32% hydrochloric acid followed by a subsequent 24 hour immersion in a hypersaline solution, and then 24 hours of drying.

FIG. 6F shows an inner surface of the flange that was in contact with the gasket during the immersions.

### DETAILED DESCRIPTION

Certain terminology is used in the following description for convenience only and is not limiting. The phrase “at least one” followed by a list of two or more items such as “A, B, or C” or “A, B, and C” means any individual one of A, B, or C as well as any combination thereof. Terms such as “approximately,” “about,” “substantially” are construed as modifying terms defined by the circumstances and as understood by those skilled in the art. The terms “corrosion” and “rust” are construed as equivalent in that metal is corroding and rust may or may not form depending on the type of metal used. The terms “infuse or infused” may also refer to “mix or mixed.” The term “dissimilar metal” may refer to two different metal types, two similar metal types having different metal combinations, or any two metals having sufficient differences such that the metals have different electrode potentials where one metal acts as an anode and another metal acts as a cathode. The terms “uniform distribution” and “evenly spread” may be used interchangeably.

An embodiment includes a composition comprising, consisting essentially of, or consisting of an elastomeric substance and a corrosion inhibitor blend. The corrosion inhibitor blend may comprise one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, Calcium dinonylnaphthalenesulfonate/carboxylate, or Zinc alkylnaphthalenesulfonate/carboxylate. In an embodiment, the corrosion inhibitor blend includes high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes. The corrosion inhibitor blend may comprise a corrosion inhibitor polar bonding oil carrier.

The concentration range of the corrosion inhibitors of the corrosion inhibitor blend may be present at a concentration range according to Table 1 below, or in a sub-range concentration range according to Table 1 below.

TABLE 1

| | | % Composition |
|---|---|---|
| | % Composition | of Inhibitor in |
| | of Inhibitor in | Corrosion |
| | Corrosion | Inhibitor Blend |
| Corrosion Inhibitor | Inhibitor Blend | Sub-range |
| High-viscosity petroleum C20-50 | 25-75 | Any subrange of |
| hydrotreated neutral oil-based lubricating | | 1% increments in |
| oils | | the range of 25-75 |
| Bis(hydrogenated tallow alkyl)dimethyl | 10-60 | Any subrange of |
| quaternary ammonium salts with | | 1% increments in |
| bentonite | | the range of 10-60 |
| Hydrotreated heavy naphtha (petroleum) | 1-10 | Any subrange of |
| | | 1% increments in |
| | | the range of 1-10 |
| Naphthalene sulfonic acid dinonyl- | 5-35 | Any subrange of |
| calcium salt | | 1% increments in |
| | | the range of 5-35 |
| Calcium carbonic acid | 2-15 | Any subrange of |
| | | 1% increments in |
| | | the range of 2-15 |
| Hydrotreated light petroleum distillates | 1-15 | Any subrange of |
| | | 1% increments in |
| | | the range of 1-15 |
| Stoddard solvent | 0-40 | Any subrange of |
| | | 1% increments in |
| | | the range of 0-40 |
| Ethyl benzene | 0.01-1 | Any subrange of |
| | | 0.01% increments |
| | | in the range of |
| | | 0.01-1 |
| Naphthalene | 0.01-1 | Any subrange of |
| | | 0.01% increments |
| | | in the range of |
| | | 0.01-1 |
| Nonane | 0.1-1 | Any subrange of |
| | | 0.1% increments |
| | | in the range of 0.1-1 |
| Pseudocumene (1,2,4-trimethyl | 0.1-1 | Any subrange of |
| benzene) | | 0.1% increments |
| | | in the range of 0.1-1 |
| Xylenes | 0.01-1 | Any subrange of |
| | | 0.01% increments |
| | | in the range of |
| | | 0.01-1 |
| Carboxy-imidazoline mixture | 5-15 | Any subrange of |
| | | 1% increments in |
| | | the range of 5-15 |
| Barium carbonate | 1-25 | Any subrange of |
| | | 1% increments in |
| | | the range of 1-25 |
| Dinonylnaphthalenesulfonic acid | 1-20 | Any subrange of |
| | | 1% increments in |
| | | the range of 1-20 |
| Calcium | 1-30 | Any subrange of |
| dinonylnaphthalenesulfonate/carboxylate | | 1% increments in |
| | | the range of 1-30 |
| Zinc | 1-25 | Any subrange of |
| alkylnaphthalenesulfonate/carboxylate | | 1% increments in |
| | | the range of 1-25 |

The corrosion inhibitor blend may have a concentration of approximately 1-30%/wt in the composition. In an embodiment, the corrosion inhibitor blend has a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges. In an embodiment, the corrosion inhibitor blend has a concentration of 20-22% in the composition. In an embodiment, the corrosion inhibitor blend has a concentration of 20% in the composition. In an embodiment, the corrosion inhibitor blend has a concentration of 22% in the composition. In an embodiment, the corrosion inhibitor blend includes anti-corrosion polar bonding oil carriers.

The elastomeric substance may include one or more of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams. In an embodiment, the elastomeric substance has elasticity. The elasticity can be achieved with the elastomeric substance itself. The elasticity may also be achieved with various additives and chemistries to make the elastomeric substance have elastic properties and flexibility to the point that they can be deformed and yet they can return to their previous shape of form. This ability to deform and return to their previous form can be referred to as having “memory.”

In an embodiment, the composition further comprises additives. The additives may be at least any one of reinforcing fillers, extending fillers, oils, stabilizers, tackifiers, resins, curatives, and other specially formulated corrosion inhibitor additives. The additives and chemistries may be included depending on the specific elastomeric substance chosen.

In an embodiment, the corrosion inhibitor blend takes the place of standard production oils in the composition. In an embodiment, the composition comprises the corrosion inhibitor blend and standard production oils. In this example, the concentration of corrosion inhibitor blend is less than the concentration of the corrosion inhibitor blend in the composition including the corrosion inhibitor blend without the standard production oils. The combined concentration of the corrosion inhibitor blend and the standard production oils may not exceed a combined concentration that would impair the properties of the elastomeric properties of the composition.

In an embodiment, the corrosion inhibitor blend is uniformly distributed throughout the composition. All elements of the composition, including the corrosion inhibitor blend, the elastomeric material, and any additives may be uniformly distributed throughout the composition.

In an embodiment, the composition comprises, consists essentially of, or consists of EPDM as the elastomeric substance. In this example, the corrosion inhibitor blend can be infused or mixed into an EPDM rubber. The corrosion inhibitor blend may have a concentration of approximately 1-30% in the composition comprising EPDM as the elastomeric substance. The corrosion inhibitor blend may have a concentration of approximately 1-30%/wt in the composition. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges. In an embodiment, the corrosion inhibitor blend has a concentration of 20-22% in the composition. The corrosion inhibitor blend may have a concentration of 20% in the composition. The corrosion inhibitor blend may have a concentration of 22% in the composition. The concentration range of each of the corrosion inhibitors of the corrosion inhibitor blend may be present at a concentration range according to Table 1 above, or in a sub-range concentration range according to Table 1 above.

In another embodiment, the composition comprises, consists essentially of, or consists of silicone as the elastomeric substance. In this example, the corrosion inhibitor blend can be infused or mixed into a silicone rubber compound. In this embodiment, the corrosion inhibitor blend has a concentration of 1-20%/wt of the final composition. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, or any interval between any of the concentration ranges. The corrosion inhibitor blend may have a concentration of 5-20% of the final composition. Because the silicone is less miscible than EPDM for example, various binding agents may be used when infusing or mixing the corrosion inhibitor blend into the silicone. The concentration range of each of the corrosion inhibitors of the corrosion inhibitor blend may be present at a concentration range according to Table 1 above, or in a sub-range concentration range according to Table 1 above.

In an embodiment, the composition comprises, consists essentially of, or consists of butyl as the elastomeric substance. In this example, the corrosion inhibitor blend can be infused or mixed into a butyl rubber compound. In this embodiment, the corrosion inhibitor blend has a concentration of 1-30%/wt of the final composition. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges. The corrosion inhibitor blend may have a concentration of 5-22% of the final composition.

The concentration range of each of the corrosion inhibitors of the corrosion inhibitor blend may be present at a concentration range according to Table 1 above, or in a sub-range concentration range according to Table 1 above.

In an embodiment, the composition comprises, consists essentially of, or consists of any one of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams as the elastomeric substance.

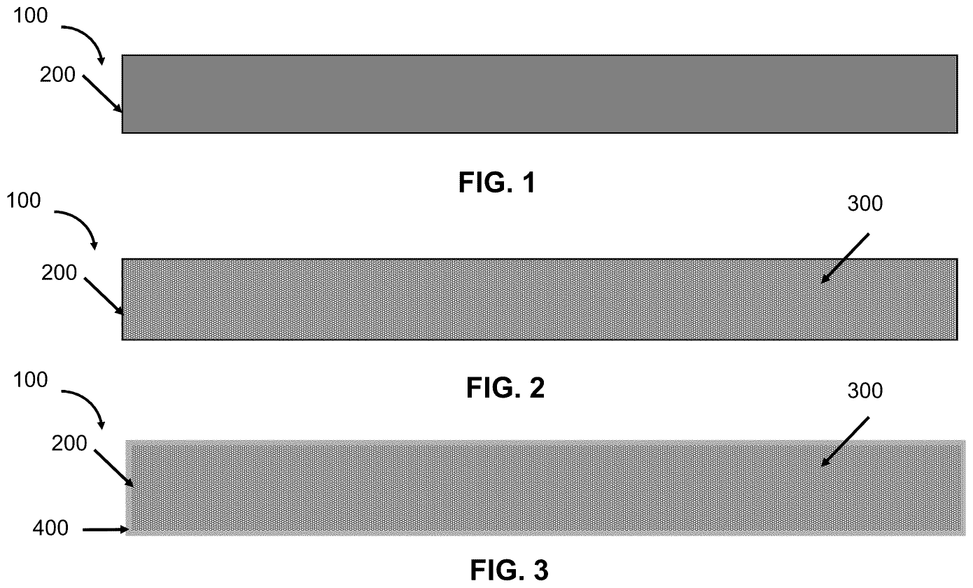

An embodiment includes an elastomeric material 100 comprising, consisting essentially of, or consisting of an elastomeric substance 200 and a corrosion inhibitor blend 300 as illustrated in FIGS. 1 and 2. The elastomeric material may have elastic properties, In an embodiment the elastic material 100 has a flexibility such that it can be deformed and can return to its previous shape or form. This ability to deform and return to its previous form may be referred to as having “memory.” The elastomeric material may also be able to retain its shape sufficiently such that it can be compressed yet still prevent contact between any surfaces to which it is interposed between. For example, the elastomeric material may have the properties of the elastomer, including but not limited to, maintaining a compressible polymer rheology and the strength of the elastomer, protecting against metal to metal contact, providing a void and holiday free pressure positive compression sealing, and durability.

In an embodiment, the elastomeric material 100 can polar bond with a metal surface based on the properties of the corrosion inhibitor blend 300. The elastomeric material 100 may have the properties of the corrosion inhibitors of the corrosion inhibitor blend 300, including but not limited to having polarity. As a result, the elastomeric material 100 comprising the corrosion inhibitor blend 300 may polar bond with a metal surface 400 to which it makes contact. The ability of the corrosion inhibitor blend 300 to polar bond to a metal surface allows for oxygen and water moisture to be displaced between the elastomeric material 100 and the metal 400, as well lock itself to the surface of the metal 400. In an embodiment, the elastomeric material 100 has anti-corrosive properties for a metal to which it makes contact. The elastomeric material may provide for a more permanent anti-corrosion ability than standard corrosion inhibitors. In an embodiment, the corrosion inhibitor blend has a high dielectric strength, which is infused into the elastomeric material, which may allow for isolation of an electric potential between a cathode and an anode of two dissimilar metals and of the electrolyte induced electron flow effect.

The corrosion inhibitor blend may have a concentration of approximately 1-30%/wt in the elastomeric material. In an embodiment, the corrosion inhibitor blend has a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges in the elastomeric material. In an embodiment, the corrosion inhibitor blend has a concentration of 20-22% in the elastomeric material. In an embodiment, the corrosion inhibitor blend has a concentration of 20% in the elastomeric material. In an embodiment, the corrosion inhibitor blend has a concentration of 22% in the elastomeric material.

The corrosion inhibitor blend may include one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, b barium carbonate, dinonylnaphthalenesulfonic acid, calcium dinonylnaphthalenesulfonate/carboxylate, or zinc alkylnaphthalenesulfonate/carboxylate. In an embodiment, the corrosive inhibitor blend of the material may include high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes. The corrosion inhibitor blend may comprise a corrosion inhibitor polar bonding oil carrier. The percent composition of each of the one or more corrosion inhibitors present in the corrosive inhibitor blend may be present at a concentration range as described in Table 1, or in any subrange of the ranges according to Table 1.

The elastomeric substance of the material may include any one or more of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams. In an embodiment, the elastomeric substance has elasticity. The elasticity can be achieved with the elastomeric substance itself. The elasticity may also be achieved with various additives and chemistries to make the elastomeric substance have elastic properties and flexibility to the point that it can be deformed and still can return to its previous shape of form.

In an embodiment, the material further comprises additives. The additives may be at least any one of reinforcing fillers, extending fillers, oils, stabilizers, tackifiers, resins, curatives, and other specially formulated corrosion inhibitor additives. The additives and chemistries may be included depending on the specific elastomeric substance chosen.

In an embodiment, the corrosion inhibitor blend takes the place of standard non-polar paraffinic production oils in the material. In an embodiment, the elastomeric material comprises the corrosion inhibitor blend and standard non-polar production oils. In this example, the concentration of corrosion inhibitor blend in the elastomeric material including the corrosion inhibitor blend is greater than the concentration of the corrosion inhibitor blend in the elastomeric material including both the corrosion inhibitor blend and the standard non-polar production oils. The combined concentration of the corrosion inhibitor blend and the standard non-polar production oils may not exceed a combined concentration that would impair the properties of the elastomeric material.

In an embodiment, the elastomeric substance of the elastomeric material is ethylene propylene diene monomer (EPDM) rubber. The corrosion inhibitor blend may have a concentration of approximately 1-30%/wt in the elastomeric material comprising EPDM as the elastomeric substance. The corrosion inhibitor blend may have a concentration of approximately 5-22% in the elastomeric material. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges. In an embodiment, the corrosion inhibitor blend has a concentration of 20-22% in the elastomeric material. The corrosion inhibitor blend may have a concentration of 20% in the elastomeric material. The corrosion inhibitor blend may have a concentration of 22% in the elastomeric material. The concentration range of each of the corrosion inhibitors of the corrosion inhibitor blend may be present at a concentration range according to Table 1 above, or in a sub-range concentration range according to Table 1 above.

In another embodiment, the elastomeric substance of the elastomeric material is silicone. In this example, the corrosion inhibitor blend can be infused or mixed into a silicone rubber compound. In this embodiment, the corrosion inhibitor blend has a concentration of 1-20%/wt of the final elastomeric material. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, or any interval between any of the concentration ranges. The corrosion inhibitor blend may have a concentration of 5-20% of the final material. Because of silicone's properties, which is less miscible than EPDM for example, various binding agents may be used when infusing or mixing the corrosion inhibitor blend into the silicone. The concentration range of each of the corrosion inhibitors of the corrosion inhibitor blend may be present at a concentration range according to Table 1 above, or in a sub-range concentration range according to Table 1 above.

In an embodiment, the elastomeric substance of the elastomeric material is butyl. In this example, the corrosion inhibitor blend can be infused or mixed into a butyl rubber compound. In this embodiment, the corrosion inhibitor blend has a concentration of 1-30%/wt of the elastomeric material. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges. The corrosion inhibitor blend may have a concentration of 5-22% of the final material.

The elastomeric material comprising the elastomeric substance and the corrosion inhibitor blend may encompass some or all of the features of the individual corrosion inhibitors of the corrosion inhibitor blend, as well as the elastomeric material. For example, the elastomeric material may have the properties of the elastomer, including but not limited to, maintaining a compressible polymer rheology and the strength of the elastomer, protecting against metal to metal contact, providing a void and holiday free pressure positive compression sealing, and durability. The elastomeric material may also be able to polar bond with a metal surface based on the properties of the corrosion inhibitor blend, thus allowing it to polar bond with a metal surface.

The elastomeric material 100 may be in the form of a gasket or other type of mechanical seal such that it fills the space between two or more mating surfaces. In an embodiment, the mating surfaces may be metal. In filling the space between two or more mating surfaces, the material may prevent leakage between the mated surfaces, often, but not always, while under compression forces. In an embodiment, the elastomeric material may be in the form of a gasket or other shape such that it contacts a metal surface or two or more metal surfaces. The two or more metal surfaces may be similar metals. The two or more metal surfaces may be dissimilar metals.

The elastomeric material may be in the shape of a flat material, including but not limited to a sheet. The material may be in the shape of a solid material, which cannot be punched out of sheets. Other non-limiting examples of the elastomeric material shape are that of a sheet gasket, a flange gasket, a ring gasket, a paper gasket, a cylinder head gasket, and any other gasket shape known in the art. In an embodiment, the elastomeric material is in the shape required for the mating of any two or more mating surfaces to fill in irregularities of a less than perfect mating. In an embodiment, the elastomeric material is in the shape required for the mating of any two or more mating surfaces to form a seal. In an embodiment, the elastomeric material is in the shape required for contacting a metal surface to which the elastomeric material will provide corrosion prevention. In an embodiment, the elastomeric material may be in the form of other shapes, including but not limited to a scupper lip.

In an embodiment, at least one of the two or more mating surfaces is a metal. In an embodiment, at least two of the two or more mating surfaces is a metal. In an embodiment, all of the two or more mating surfaces is a metal. In an embodiment, the at least two or more mating surfaces are similar metals. In an embodiment, the at least two or more metal surfaces are dissimilar metals. In an embodiment, the elastomeric material contacts a single metal surface. In an embodiment, the elastomeric material prevents corrosion of the metal surface to which it makes contact.

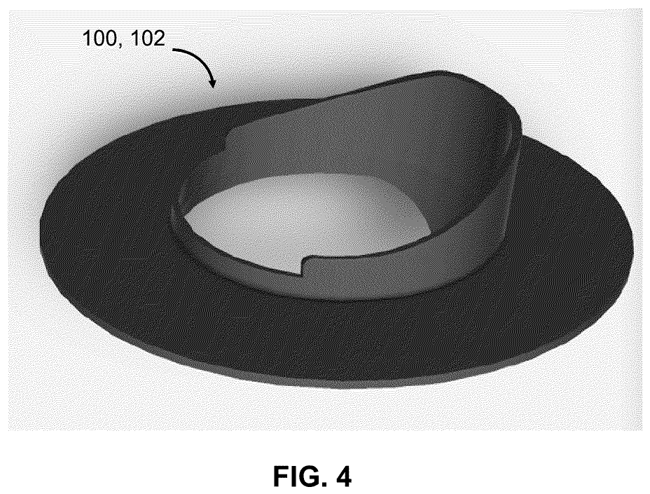

The elastomeric material comprising, consisting essentially of, or consisting of an elastomeric substance and at least one corrosion inhibitor or corrosion inhibitor blend may be formed into many shapes for marine use (FIG. 4). Non-limiting examples include ship louvers, ship scuppers 102, deck machinery base plates, electronic connections, pump housing, and other marine uses. In an embodiment, an elastomeric material comprising, consisting essentially of, or consisting of an elastomeric substance and a corrosion inhibitor blend can be formed into many shapes for use in high corrosivity marine uses. The elastomeric material may also be used in non-marine industrial corrosion preventive uses.

In an embodiment, all elements of the elastomeric material, including the corrosion inhibitor blend, the elastomeric substance, and any additives are uniformly distributed throughout the elastomeric material. In an embodiment, the corrosion inhibitor blend is uniformly distributed throughout the elastomeric material. Having a uniform distribution of corrosion inhibitor allows for the corrosion inhibitor blend to be spread throughout the product.

The uniform distribution of the corrosion inhibitor blend combined with the elastomeric properties of the elastomeric material, allows for the corrosion inhibitor blend to bleed out of the material and contact a metal surface regardless of whether the elastomeric material is stretched out or relaxed. In both the relaxed state or the stretched out state the corrosion inhibitor blend can be released or exuded and contact a metal surface. For example, in the case of the elastomeric material in the shape of a gasket, no matter how much the gasket is compressed, its surface is always in contact with corrosion inhibitor blend of the elastomeric material. In an embodiment, for the corrosion inhibitor blend to bleed out refers to the release of corrosion inhibitor blend from the elastomeric material. Upon bleeding out, the corrosion inhibitor blend may leave a residue in the metal surface. The residue may be in the form of a thin film. In an embodiment, the thin film is a microfilm. Such a film may remain on the metal surface and prevents corrosion for an extended period of time. The polar bonding of the corrosion inhibitor blend to the metal surface allows for the corrosion inhibitor blend to latch onto the metal surface for extended periods of time. In an embodiment, the corrosion inhibitor blend remains on the metal surface for 1 day to 10 years. The corrosion inhibitor blend remains on the metal surface for a period of any of days, months, or years. In an embodiment, the corrosion inhibitor layer may be removed in the presence of a high pH and/or a detergent.

An embodiment includes an elastomeric material comprising, consisting essentially of, or consisting of an elastomeric substance, whereby a butyl layer comprising a corrosion inhibitor blend is layered on the elastomeric material. The butyl layer may be layered on one side of the elastomeric material, or the butyl layer may be layered on two or more sides of the elastomeric material. In an embodiment, the two sides are opposing sides. In an embodiment, the butyl layer is layered on the surface of the elastomeric material side(s). The butyl layer may be sticky and be able to adhere onto the elastomeric material.

The elastomeric material may be in the form of a gasket, a sheet, or any other form described herein. In such an example, the composition could be introduced to one or both sides of such a gasket or sheet, in particular if the surfaces are rough, more complex, and/or susceptible to a large amount of motion and vibration. One-sided application may facilitate location and/or allow for ease of disassembly when required, for example for regular cleaning or maintenance. In an embodiment, the butyl layer is stuck onto a metal surface. This allows for the butyl layer including the corrosion inhibitor blend to be held in place on the metal surface, especially in instances where there is no compression force to hold it in place.

In an embodiment, the elastomeric substance of the elastomeric material includes any one or more of a natural rubber, polyisoprene, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams. In an embodiment, the elastomeric substance of the elastomeric material is ethylene propylene diene monomer (EPDM) rubber. In an embodiment, the elastomeric material has elasticity.

In an embodiment, the elastomeric material also comprises a corrosion inhibitor blend. In this example, both the elastomeric material and the butyl layer have a corrosion inhibitor blend. The concentration range of each of the corrosion inhibitors of the corrosion inhibitor blend may be present at a concentration range according to Table 1 above, or in a sub-range concentration range according to Table 1 above.

The corrosion inhibitor blend may have a concentration of approximately 1-30%/wt in the elastomeric material. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges in the elastomeric material. In an embodiment, the corrosion inhibitor blend has a concentration of 20-22% in the elastomeric material. The corrosion inhibitor blend may have a concentration of 20% in the elastomeric material. The corrosion inhibitor blend may have a concentration of 22% in the elastomeric material.

The corrosion inhibitor blend may have a concentration of approximately 1-30% in the butyl layer. The corrosion inhibitor blend may have a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges in the butyl layer.

In an embodiment, the concentration of corrosion inhibitor blend in the elastomeric material is the same as the concentration of corrosion inhibitor blend in the butyl layer. In an embodiment, the concentration of corrosion inhibitor blend in the elastomeric material is different than the concentration of corrosion inhibitor blend in the butyl layer. The concentration of corrosion inhibitor blend in the elastomeric material may be greater than the concentration of corrosion inhibitor blend in the butyl layer. The concentration of corrosion inhibitor blend in the elastomeric material may be less than the concentration of corrosion inhibitor blend in the butyl layer.

The elastomeric material having a butyl layer comprising a corrosion inhibitor blend layered on the elastomeric material, can encompass some or all of the features of the individual constituents. The elastomeric material and/or butyl layer may still be durable, have a compressible polymer rheology, and a strength to protect against metal to metal contact for example. The corrosion inhibitor blend itself can polar bond with a metal surface, thereby preventing the effects of electrolysis on the metals to which the butyl layer contacts, and thereby preventing corrosion of the metal.

The elastomeric material having a butyl layer comprising a corrosion inhibitor blend may be formed into many shapes for marine use. Non-limiting examples include ship louvers, ship scuppers, deck machinery base plates, electronic connections, pump housing, and other marine uses. In an embodiment, the elastomeric material having the butyl layer can be formed into multiple shapes.

In an embodiment, the butyl layer including the corrosion inhibitor blend may be applied to elastomeric substance post manufacture. The butyl layer including the corrosion inhibitor blend may be sticky in nature and be adhered onto a metal surface. In an example, the butyl layer including the corrosion inhibitor blend may be cold laminated directly to the elastomeric material. The product formed could then be cut to required gasket shapes for example using a variety of different cutting technologies, as determined by the gasket manufacturer from the elastomeric substance.

In an embodiment, the butyl layer having the corrosion inhibitor blend has a release liner on one side. The butyl layer could be manufactured in roll form for lamination to a flat elastomeric substance, such as EPDM for example. In an embodiment, the elastomeric substance, such as EPDM, is in roll form. In such an embodiment, the butyl layer having the corrosion inhibitor blend may be directly extruded or calendared directly onto the elastomeric substance. In an embodiment, a release liner is introduced post coating so that the composite is directly formed without cold laminating. It is not readily possible to cold laminate and create a rolled formed elastomeric substance infused with corrosion inhibitors, with a butyl pressure sensitive adhesive. In such an embodiment, the liner may be introduced post coating in the rolled form.

An embodiment includes a method of preventing corrosion of a metal comprising, consisting essentially of, or consisting of placing an elastomeric material in contact with a metal surface of the metal. The elastomeric material may comprise an elastomeric substance and a corrosion inhibitor blend, where the corrosion inhibitor blend may bleed out or exude from the elastomeric material such that it polar bonds with the metal. This may allow for oxygen and water moisture to be displaced between the elastomeric material and the metal, as well locking itself to the surface of the metal providing for more permanent anti-corrosion ability than standard corrosion inhibitors. The corrosion inhibitor blend when on the surface of the metal, may isolate an electric potential between a cathode and an anode of two dissimilar metals, and the electrolyte induced electron flow effect of the electrolysis cycle. The elastomeric material may further comprise a butyl layer including a corrosion inhibitor blend, on a surface of the elastomeric material.

The corrosion inhibitor blend may have a concentration of approximately 1-30%/wt in the elastomeric material. In an embodiment, the corrosion inhibitor blend has a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges. In an embodiment, the corrosion inhibitor blend has a concentration of 20-22% in the elastomeric material. In an embodiment, the corrosion inhibitor blend has a concentration of 20% in the elastomeric material. In an embodiment, the corrosion inhibitor blend has a concentration of 22% in the elastomeric material.

The corrosion inhibitor blend may include one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate. The corrosion inhibitor blend may comprise a corrosion inhibitor polar bonding oil carrier. In an embodiment, the corrosive inhibitor blend of the elastomeric material may include high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes. The percent composition of each of the one or more corrosion inhibitors present in the corrosive inhibitor blend may be present at a concentration range as described in Table 1, or in any subrange of the ranges according to Table 1.

The elastomeric substance of the elastomeric material may include any one or more of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams. In an embodiment, the elastomeric substance has elasticity. The elasticity can be achieved with the elastomeric substance itself. The elasticity may also be achieved with various additives and chemistries to make the elastomeric substance have elastic properties and flexibility to the point that they can be deformed and yet they can return to their previous shape of form. This ability to deform and return to their previous form can be referred to as having “memory.”

In an embodiment, the elastomeric material further comprises additives. The additives may be at least any one of reinforcing fillers, extending fillers, oils, stabilizers, tackifiers, resins, curatives, and other specially formulated corrosion inhibitor additives. The additives and chemistries may be included depending on the specific elastomeric substance chosen.

The method may comprise placing the elastomeric material on or in contact with a metal surface. In an embodiment, the elastomeric material is placed on the metal surface in an air tight and water tight manner. The method may comprise interposing the elastomeric material, preferably a corrosion preventive gasket, between two metal surfaces, such as flanges, or joints. In an embodiment, the elastomeric material is interposed between two metal surfaces in an air tight and water tight manner. In an embodiment, the two metal surfaces are a similar metal type. In an embodiment, the two metal surfaces are a different metal type. The elastomeric material can therefore prevent bimetallic corrosion where the two metals come together. In an embodiment, three or more metals may come together and have the elastomeric material interposed between their surfaces.

The method may further comprise forming a seal using a gasket or other type of mechanical seal such that it fills the space between two or more mating surfaces. In an embodiment, the mating surfaces may be metal. The metals may be dissimilar metals. In filling the space between two or more mating surfaces, the elastomeric material may prevent leakage between the mated surfaces, often, but not always, while under compression forces. The elastomeric material may also bleed or exude the corrosion inhibitor blend onto the metal surface for protection of the metal from corrosion.

In an embodiment, any one or more of or all elements of the elastomeric material, including the corrosion inhibitor blend, the elastomeric substance, and any additives may be uniformly distributed throughout the material. Having a uniform distribution of corrosion inhibitor allows for the corrosion inhibitor blend to be spread throughout the product.

Non-limiting examples of settings where different metals may be interposed by the elastomeric material, preferably a corrosion preventive gasket, include hoses, including coolant, heater, brake, air conditioning, and air; HVAC systems, radiator seals; weather strips and sealing systems; molded gaskets and ducts; hydraulic wipers and seals; tire and tube applications; electrical insulation and jacketing with medium to high dielectric strength; connectors, including tapes and wraps; conveyor belts, roll coverings; hydraulic connector corrosion isolations; equipment base plate isolation; king post and windlass base mounts; roofing sheets isolation packing; window profile isolators and seals; extruded gaskets and associated parts; ship's louvres mounted to bulkheads; hatch mounts mounted to bulkheads and marine compartments; ship scuppers; building scuppers; electrolysis isolation packing seals; and parts in storage or transport that are in wrapping films. The uniform distribution of the corrosion inhibitor blend combined with the elastomeric properties of the elastomeric material, allows for the corrosion inhibitor blend to bleed out of the elastomeric material and contact a metal surface regardless of whether the material is stretched out or relaxed. In both the relaxed state or the stretched out state the corrosion inhibitor blend can be released or exuded and contact a metal surface. For example, in the case of the material in the shape of a gasket, no matter how much the gasket is compressed, its surface is always in contact with corrosion inhibitor blend of the material at least in part due to the uniform distribution of the corrosion inhibitor blend throughout the elastomeric material.

In an embodiment, for the corrosion inhibitor blend to bleed out refers to the release of corrosion inhibitor blend from the elastomeric material. Upon bleeding out, the corrosion inhibitor blend may leave a residue on the metal surface. The residue may be in the form of a thin film. In an embodiment, the thin film is a microfilm. Such a film remains on the metal surface and prevents corrosion for an extended period of time. The polar bonding of the corrosion inhibitor blend to the metal surface allows for the corrosion inhibitor blend to latch onto the metal surface for extended periods of time. In an embodiment, the corrosion inhibitor blend remains on the metal surface for 1 day to 10 years. The corrosion inhibitor blend remains on the metal surface for a period of any of days, months, or years. In an embodiment, the corrosion inhibitor layer may be removed in the presence of a high pH or a detergent.

The elastomeric material, may act as a release film/agent and leave a fitting where the elastomeric material is interposed with a corrosion free surface. In an embodiment, the corrosion free surface is at least one that is not corroded, and does not need to be mechanically abraded, scraped, or have the surface ground in order to perform its function. In this instance, when the fitting with the elastomeric material, preferably a corrosion preventive gasket, needs to be disassembled it may be easy to remove and/or reinstall. This may make it easier to replace individual components because not all metal pieces would be corroded.

The method of preventing corrosion further comprises sealing a gap between the two surfaces or joints. In an embodiment, the sealing occurs from a coming together of the surfaces or joints. In an embodiment, the sealing further comprises exerting a compressive force on the corrosion preventive gasket.

The elastomeric material, preferably a corrosion preventive gasket, may be used for marine use. Non-limiting examples include ship scuppers, ship louvers, deck machinery base plates, electronic connections, pump housing, and other marine uses. In an embodiment, the corrosion preventive gasket can be used in high corrosivity marine uses. The corrosion preventive gasket may also be used in non-marine industrial corrosion preventive uses. Non-marine examples of use include an elastomeric material having the shape of a scupper lip of a building.

An embodiment includes a method of making a corrosion resistant elastomeric material comprising an elastomeric substance and a corrosion inhibitor blend. The method comprises, consists essentially of, or consists of mixing one or more corrosion inhibitors to form the corrosion inhibitor blend. The corrosion inhibitor blend may be in the form of a lubricant. The method may further comprise compounding the elastomeric substance. In an embodiment, the method may comprise infusing the corrosion inhibitor blend with the elastomeric substance during the compounding. The corrosion inhibitor blend may be compounded until a composited material is formed.

The corrosion inhibitor blend may be present in the elastomeric material at a range of 1-30%/wt. In an embodiment, the corrosion inhibitor blend is present in the elastomeric material at a range of 5-22%. In an embodiment, the corrosion inhibitor blend has a concentration of 1-2%, 2-3%, 3-4%, 4-5%, 5-6%, 6-7%, 7-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26%, 26-27%, 27-28%, 28-29%, 29-30%, or any interval between any of the concentration ranges in the elastomeric material. In an embodiment, the corrosion inhibitor blend is present in the elastomeric material at a range of 20-22%/wt.

The method further comprises curing of the material. The material may also be autoclaved and/or vulcanized, the order of which can be rearranged. In an embodiment, the uncured elastomeric substance and the corrosion inhibitor blend may be stored as a masterbatch prior to curing, autoclaving, and/or vulcanizing.

In an embodiment, the curing and/or vulcanization comprises heating the elastomeric material and molding it into a shape that corresponds with any fitting in need of a corrosive preventative elastomeric material. Non-limiting examples of the shape are that of a gasket, a sheet, or a scupper lip. In an embodiment, the heating is done by any one of a heat tunnel, autoclave or vulcanizing method, or various combinations thereof.

The method of making the elastomeric material comprising an elastomeric substance and a corrosion inhibitor blend comprises mixing or compounding one or more of the corrosion inhibitor blend with the elastomeric substance to form a composited material. In an embodiment, the compounding of the corrosion inhibitor blend occurs after compounding the elastomer itself into an uncured paste consistency. In an embodiment, the compounding of the elastomeric substance with the corrosion inhibitor blend is into an uncured paste consistency.

In an embodiment, the method of making a composition comprising an elastomeric substance and a corrosion inhibitor blend further comprises adding any one or more of the following additives: reinforcing fillers, extending fillers, oils, stabilizers, tackifiers, resins, curatives, and other specially formulated corrosion inhibitor additives. Adding of the additives may occur by compounding, either with the elastomeric substance alone or with the combined elastomeric substance and corrosion inhibitor blend.

In an embodiment where butyl is infused with the corrosion inhibitor blend, the method of making a composition comprising an elastomeric substance and a corrosion inhibitor blend includes adding any one or more of the following additives to at least one of the butyl or the elastomeric substance: reinforcing fillers, extending fillers, process oils, stabilizers, tackifiers, resins, curatives, and other specially formulated corrosion inhibitor additives. Mixing of the additives may occur with the butyl alone or with the combined butyl and corrosion inhibitor blend.

In an embodiment, a specific sequence of mixing of at least two of the elastomeric substance, corrosion inhibitors, and additives is used. The mixing process is a combination format that may include a one pass or multiple pass heated mixing. Temperature and time conditions may vary depending on at least the formulation, the raw materials used (for example whether they come in a liquid or powder form), the infrastructure (for example the mixing ability, paddle size, batch size, pump size, recirculation, bubbling, dispersion, kettle shape, and other). In an embodiment, the temperature ranges from 15° C. to 80° C. In an embodiment, the temperature ranges from ambient temperature to 80° C. The time used to mix and/or heat samples may also vary greatly. In an embodiment, the time to mix and/or heat samples is in the range of 1 hour to 8 hours.

The method may further include any one or more of shaping, extruding, molding, or calendaring. The calendaring process may facilitate the smoothing and compression of all ingredients at the incorporation phase whereby the raw materials and additives are introduced into the pairs of heated rollers, preferably the calendar rollers. The calendaring may occur during the compounding of the elastomeric substance and the corrosion inhibitor blend, or during the compounding of the elastomeric substance, the corrosion inhibitor blend, and the additive. The calendaring facilitates smoothing and compression of all ingredients of elastomeric material and preferably eliminates any dry/unwetted zones to eliminate uncurable areas of the elastomeric material infused with the corrosion inhibitor blend and other additives In an embodiment, the method further includes a curing or vulcanization step.

In an embodiment, the curing comprises heating the composition and molding the composition into an elastomeric material, having a shape that corresponds with any fitting in need of the elastomeric material. Non-limiting examples of the shape are that of a gasket, a sheet, or a scupper lip. In an embodiment, the heating is done by a heat tunnel, autoclave or vulcanizing method, or various combinations thereof.

The elastomeric substance may include one or more of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams. In an embodiment, the elastomeric substance is EPDM rubber.

The one or more corrosion inhibitors of the corrosion inhibitor blend may be selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate. The corrosion inhibitor blend may comprise a corrosion inhibitor polar bonding oil carrier. In an embodiment, the corrosion inhibitor blend is comprised of high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes. In an embodiment, the mixing of the one or more corrosion inhibitors into the corrosion inhibitor blend forms a lubricant.

The method of making an elastomeric material comprising an elastomeric substance and a corrosion inhibitor blend may comprise forming the corrosion inhibitor blend. Forming the corrosion inhibitor blend may occur by combining any one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate. In an embodiment, the corrosion inhibitor blend is formed by combining any one or more corrosion inhibitors selected from the group consisting of high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes. In an embodiment, the mixing of the one or more corrosion inhibitors into the corrosion inhibitor blend forms a lubricant.

In an embodiment, the corrosion inhibitor blend may be introduced at a specific phase of mixing and at a specific range of concentrations from 1-30% by weight of the elastomeric material. The corrosion inhibitor blend may be introduced at a specific phase of mixing and at a specific range of concentrations from 5-22% by weight. In an embodiment, the corrosion inhibitor blend may be introduced at a specific phase of mixing and at a specific range of concentrations from 20-22% by weight. A homogeneous elastomeric material may be formed comprising all constituents fused into a new purpose designed form of functional elastomeric material. In an embodiment, the corrosion inhibitor blend is compounded into the elastomeric substance and fully blended/mixed into the final uncured masterbatch composition.

In an embodiment, the mixing, compounding, and calendaring of the corrosion inhibitor blend, elastomeric substance, and additives when present proceeds according to eliminate clumping, lumps, and undispersed constituents throughout the mixing and/or compounding phase. This may eliminate the probability of dry/unwetted zones to eliminate uncurable areas of the mixed compound.

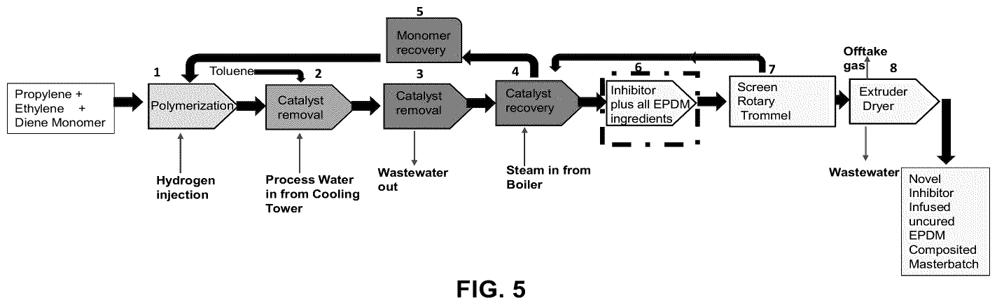

In an embodiment, the corrosion inhibitor blend is formulated and blended prior to being compounded into the elastomeric material. As shown in FIG. 5, the elastomeric material may be raw EPDM material. In such an example, propylene, ethylene, and diene monomer are polymerized in the presence of a catalyst according to FIG. 5. Upon catalyst removal and recovery, as well as monomer recovery, the polymerized EPDM is mixed and/or compounded with the corrosion inhibitor blend. The elastomeric substance, or more specifically EPDM in this example, may first be compounded with all of the polymers and additives until the elastomeric substance plus additives formulation is at a consistency that it will accept the corrosion inhibitor blend into the raw uncured elastomeric substance. Meaning that the elastomeric substance formulation and the corrosion inhibitor blend formulation may first be separately completed, after which both the elastomeric substance and the corrosion inhibitor blend can be mixed and compounded. In such an example, all the components of the raw elastomeric substance are totally integrated and uniform before the corrosion inhibitor blend is introduced. This may be useful because elastomeric substances, such as EPDM, may have many powdered additives, such as carbon black and/or calcium carbonate, that must be completely and uniformly blended to prevent “dry spots.” Based on at least such, the corrosion inhibitor blend may then be carried evenly throughout the raw EPDM compound. The corrosion inhibitor blend may include anti-corrosion polar bonding oil carriers with corrosion inhibitors blended in. The blending may occur over many cycles and folding back into the calendaring machine. In the embodiment, both key components are made up of their own specific formulations, prior to being composited together to form the new gasket material. In an embodiment, the elastomeric substance, or more specifically EPDM in this example, may first be compounded with all of the polymers, corrosion inhibitor blend, and additives, which will then be formed into the raw uncured elastomeric material.

In an embodiment, the un-composited, mixed composition may be stored prior to curing and/or vulcanization.

### EMBODIMENTS OF THE DETAILED DESCRIPTION

1. A composition comprising, consisting essentially of, or consisting of an elastomeric substance and a corrosion inhibitor blend.
2. The composition of embodiment 1, wherein the corrosion inhibitor blend is selected from one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate.
3. The composition of any one of embodiments 1-2, wherein the elastomeric substance comprises at least one of natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams.
4. The composition of any one of embodiments 1-3, wherein the elastomeric substance comprises ethylene propylene diene monomer (EPDM) rubber.
5. The composition of any one of embodiments 1-4, wherein a percent of each corrosion inhibitor of the one or more corrosion inhibitors in the corrosion inhibitor blend is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 0-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the calcium dinonylnaphthalenesulfonate/carboxylate when present, or 1-25% for the zinc alkylnaphthalenesulfonate/carboxylate when present.
6. The composition of any one of embodiments 1-5, wherein the one or more corrosion inhibitors of the corrosion inhibitor blend comprises high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes.
7. The composition of any one of embodiments 1-6, wherein the corrosion inhibitor blend is present in the composition at a range of 1-30% wt/wt.
8. The composition of any one of embodiments 1-7, wherein the corrosion inhibitor blend is present in the composition at a range of 20-22% wt/wt.
9. The composition of any one of embodiments 1-8, further comprising reinforcing fillers, extending fillers, oils, stabilizers, curatives and other specially formulated corrosion inhibitor additives.
10. An elastomeric material comprising, consisting essentially of, or consisting of a corrosion inhibitor blend and an elastomeric substance.
11. The elastomeric material of embodiment 10, wherein the corrosion inhibitor blend is present in the material at a range of 1-30% wt/wt.
12. The elastomeric material of any one of embodiments 10-11, wherein the corrosion inhibitor blend polar bonds with a metal.
13. The elastomeric material of any one of embodiments 10-12, wherein the elastomeric material prevents corrosion of the metal through contact of the elastomeric material with the metal.
14. The elastomeric material of any one of embodiments 10-13, wherein the corrosion inhibitor blend comprises one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy imidazoline mixture, barium carbonate, dinonylnaphthalenesulfonic acid, calcium dinonylnaphthalenesulfonate/carboxylate, or zinc alkylnaphthalenesulfonate/carboxylate.
15. The elastomeric material of any one of embodiments 10-14, wherein the corrosion inhibitor blend comprises high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes.
16. The elastomeric material of any one of embodiments 10-15, wherein the elastomeric substance comprises at least one of natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams.
17. The elastomeric material of any one of embodiments 10-16, wherein the elastomeric substance comprises ethylene propylene diene monomer (EPDM) rubber.
18. The elastomeric material of any one of embodiments 10-17, wherein a percent of each corrosion inhibitor of the one or more corrosion inhibitors in the corrosion inhibitor blend is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 0-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the Calcium dinonylnaphthalenesulfonate/carboxylate when present, or 1-25% for the Zinc alkylnaphthalenesulfonate/carboxylate when present.
19. The elastomeric material of any one of embodiments 10-18, wherein the corrosion inhibitor blend is present at a range of 5-22% wt/wt.
20. The elastomeric material of any one of embodiments 10-19, wherein the corrosion inhibitor blend is present at a range of 20-22% wt/wt.
21. The elastomeric material of any one of embodiments 10-20, wherein the corrosion inhibitor blend is present at 20% or 22% wt/wt.
22. The elastomeric material of any one of embodiments 10-21, further comprising reinforcing fillers, extending fillers, oils, stabilizers, curatives and other specially formulated corrosion inhibitor additives.
23. The elastomeric material of any one of embodiments 10-22, wherein the corrosion inhibitor blend is evenly spread throughout the corrosion resistant material.
24. The elastomeric material of any one of embodiments 10-23, wherein the corrosion inhibitor blend bleeds out from the elastomeric material and polar bonds with the metal.
25. The elastomeric material of any one of embodiments 10-24, wherein the corrosion inhibitor blend bleeds out from the elastomeric material and polar bonds with the metal at any thickness of the elastomeric material, whether the elastomeric material is compressed or relaxed.
26. The elastomeric material of any one of embodiments 10-25, wherein the elastomeric material can be in the form of at least any one of a sheet gasket, a flange gasket, a ring gasket, a paper gasket, a cylinder head gasket, a molded gasket, an extruded gaskets and associated parts, a hose, a weather strip, a sealing system, a hydraulic wiper, a seal, a connector, a conveyor belt, a roll covering, a king post and windless base mount, a roofing sheet isolation packing, a window profile isolator and seal, a ship louvre mounted to bulkheads, a hatch mount mounted to bulkheads and marine compartments; a scupper lip, a ship scupper, a building scupper, tire and tube applications, electrical insulation and jacketing with medium to high dielectric strength, electrolysis isolation packing seals, and parts in storage or transport that are in wrapping films.
27. The elastomeric material of any one of embodiments 10-26, further comprising a butyl layer on a surface of the elastomeric material, wherein the butyl layer comprises the corrosion inhibitor blend.
28. A method of making an elastomeric material comprising, consisting essentially of, or consisting of an elastomeric substance and a corrosion inhibitor blend.
29. The method of embodiment 28 further comprising mixing one or more corrosion inhibitors to form the corrosion inhibitor blend.
30. The method of any one of embodiments 28-29 further comprising compounding the elastomeric substance.
31. The method of any one of embodiments 28-30 further comprising infusing of the corrosion inhibitor blend with the elastomeric substance during the compounding.
32. The method of any one of embodiments 28-31 further comprising curing of the composited material to form the elastomeric material.
33. The method of any one of embodiments 28-32, wherein the corrosion inhibitor blend is present in the elastomeric material at a range of 1-30% wt/wt.
34. The method of any one of embodiments 28-33, wherein the corrosion inhibitor blend polar bonds with a metal.
35. The method of any one of embodiments 28-34, wherein the elastomeric material prevents corrosion of the metal through contact of the elastomeric material with the metal.
36. The method of any one of embodiments 28-35, wherein the corrosion inhibitor blend comprises one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate.
37. The method of any one of embodiments 28-36, wherein a percent of each corrosion inhibitor of the one or more corrosion inhibitors in the corrosion inhibitor blend is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 0-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the calcium dinonylnaphthalenesulfonate/carboxylate when present, or 1-25% for the zinc alkylnaphthalenesulfonate/carboxylate when present.
38. The method of any one of embodiments 28-37, wherein the compounding and infusing of the corrosion inhibitor blend with the elastomeric substance further comprises adding any one or more of the following additives: reinforcing fillers, extending fillers, process oils, stabilizers, curatives and other specially formulated corrosion inhibitor additives.
39. The method of any one of embodiments 28-38, further comprising calendaring of the elastomeric material with heated rollers comprising a one pass or multiple pass heated mixing.
40. The method of any one of embodiments 28-39, wherein the calendaring occurs during the compounding.
41. The method of any one of embodiments 28-40, wherein the corrosion inhibitor blend and additives are added during the calendaring.
42. The method of any one of embodiments 28-41, wherein the calendaring facilitates smoothing and compression of all ingredients of corrosion resistant material and preferably eliminates any dry/unwetted zones to eliminate uncurable areas of the corrosion resistant material infused with the corrosion inhibitor blend and other additives.
43. The method of any one of embodiments 28-42 further comprising molding the elastomeric material comprising the corrosion inhibitor blend and the elastomeric substance into a gasket-like shape prior to curing.
44. The method of any one of embodiments 28-43, wherein the curing comprises heating the composited material comprising the corrosion inhibitor blend and the elastomeric material.
45. A method of preventing corrosion of a metal comprising placing an elastomeric material in contact with the metal.
46. The method of embodiment 45, wherein the material comprises an elastomeric substance and a corrosion inhibitor blend.
47. The method of any one of embodiments 45-46, wherein the corrosion inhibitor blend is present in the elastomeric material at a range of 1-30% wt/wt in the elastomeric material.
48. The method of any one of embodiments 45-47, wherein the corrosion inhibitor blend bleeds out from the elastomeric material and polar bonds with the metal.
49. The method of any one of embodiments 45-48, wherein the corrosion inhibitor blend comprises one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate.
50. The method of any one of embodiments 45-49, wherein a percent of each corrosion inhibitor of the one or more corrosion inhibitors in the corrosion inhibitor blend is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 0-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the calcium dinonylnaphthalenesulfonate/carboxylate when present, or 1-25% for the zinc alkylnaphthalenesulfonate/carboxylate when present.
51. The method of any one of embodiments 45-50, wherein the elastomeric substance comprises at least one of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams.
52. The method of any one of embodiments 45-51, wherein the elastomeric substance comprises ethylene propylene diene monomer (EPDM) rubber and the corrosion inhibitor blend is present in the material at a range of 20-22% wt/wt.
53. The method of any one of embodiments 45-52, wherein the placing of the elastomeric material is on a metal surface.
54. The method of any one of embodiments 45-52, wherein the placing of the elastomeric material is between two metal surfaces, wherein each metal of the two metal surfaces is similar.
55. The method of any one of embodiments 45-52, wherein the placing of the elastomeric material is between two metal surfaces, wherein each metal of the two metal surfaces is dissimilar.
56. The method of any one of embodiments 45-55, further comprising sealing of a gap between the two metal surfaces.
57. The method of any one of embodiments 45-56, the sealing occurs from a coming together of the two metal surfaces and exerting compressive forces on the material.
58. A use of an elastomeric material for preventing corrosion of metal parts, the corrosion preventive material comprising, consisting essentially of, or consisting of an elastomeric substance and a corrosion inhibitor blend, wherein the corrosion inhibitor blend comprises one or more of a corrosion inhibitor.
59. The use of an elastomeric material of embodiment 58, wherein the elastomeric material prevents corrosion of a metal surface to which it makes contact.
60. The use of an elastomeric material of any one of embodiments 58-59, wherein the corrosion inhibitor blend comprises one or more corrosion inhibitors selected from the group consisting of high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate.
61. The use of an elastomeric material for preventing corrosion of metal parts of any one of embodiments 58-60, wherein the elastomeric substance comprises at least one of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams.
62. The use of an elastomeric material of any one of embodiments 58-61, wherein the elastomeric substance comprises ethylene propylene diene monomer (EPDM) rubber.
63. The use of an elastomeric material material of any one of embodiments 58-62, wherein a percent of each of the one or more corrosion inhibitors of the corrosion inhibitor blend in the composition is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 1-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the calcium dinonylnaphthalenesulfonate/carboxylate when present, or 1-25% for the zinc alkylnaphthalenesulfonate/carboxylate when present.
64. The use of an elastomeric material of any one of embodiments 58-63, wherein the corrosion inhibitor blend comprises, consists essentially of, or consists of high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes.
65. The use of an elastomeric material of any one of embodiments 58-64, placing a corrosion preventive material on a surface of a metal part.
66. The use of an elastomeric material of any one of embodiments 58-65, placing a corrosion preventive material between two surfaces or joints of metal parts.

### EXAMPLES

### Example 1

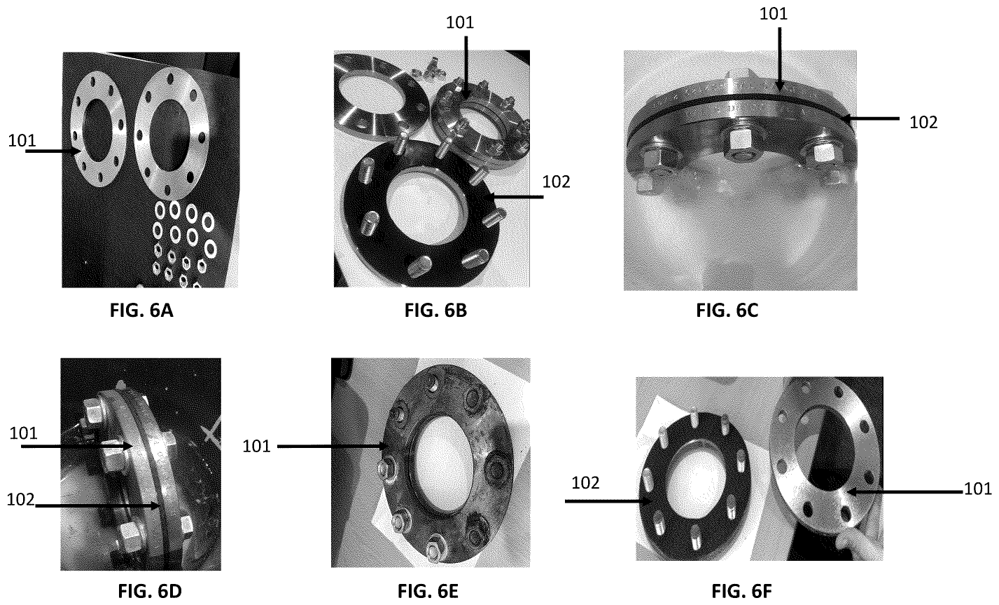

A new flange 101 was assembled with a gasket 102 material comprising EPDM and the corrosion inhibitor blend and subject to accelerated corrosion testing. The corrosion inhibitor blend was at a concentration of 20-22% by weight of the final gasket material. (FIGS. 6A and 6B). The flange-gasket assembly was immersed in 32% hydrochloric acid (HCl) for 24 hours at 21 degrees Celsius. FIG. 6C illustrates the immersion in HCl, and further demonstrates the immediate HCl vapour contacting the upper half of the immersed flange-gasket assembly. The flange-gasket assembly was then transferred and immersed in a hypersaline solution for 24 hours at 21 degrees Celsius, at a same or similar level of immersion of the flange-gasket assembly in the concentrated HCl solution. The hypersaline solution was a 500 grams of sea salt to 1 kg water solution. In comparison, seawater averages 35 grams salt per 1 kg water and Dead Sea water averages approximately 330 grams of sea salt to 1 kg of water. After 24 hours in the hypersaline solution, the flange-gasket assembly was removed and dried for 24 hours where it developed a salt layer on the surface as shown in FIG. 6E. FIG. 6E further demonstrates corrosion of the flange 102, with the portion that was immersed having a greater degree of corrosion than the portion that was only exposed to concentrated HCl vapours. The flange 101 was then opened and the gasket 102 was removed to show the inner metal surfaces of the flange 101 that were in contact with the gasket 102. These protected surfaces appeared new and did not demonstrate any degree of corrosion following the immersion treatments in concentrated HCl and a hypersaline solution. This treatment of the metal flange illustrates how the gasket material comprising EPDM and the corrosion inhibitor blend is resistant to corrosion.

While the present invention has been described in terms of its specific embodiments, certain modifications and equivalents will be apparent to those skilled in the art and are intended to be included within the scope of the present invention.

1. An elastomeric material comprising an elastomeric substance and a corrosion inhibitor blend, wherein
the corrosion inhibitor blend is present in the material at a range of 1-30% wt/wt;
the corrosion inhibitor blend polar bonds with a metal; and
the elastomeric material prevents corrosion of the metal through contact of the elastomeric material with the metal.

2. The elastomeric material of claim 1, wherein the corrosion inhibitor blend comprises one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate.

3. The material of claim 2, wherein a percent of each corrosion inhibitor of the one or more corrosion inhibitors in the corrosion inhibitor blend is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 0-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the calcium dinonylnaphthalenesulfonate/carboxylate when present, or 1-25% for the zinc alkylnaphthalenesulfonate/carboxylate when present.

4. The elastomeric material of claim 1, wherein the elastomeric substance comprises at least one of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams.

5. The elastomeric material of claim 4, wherein the elastomeric substance comprises ethylene propylene diene monomer (EPDM) rubber.

6. The elastomeric material of claim 1, wherein the corrosion inhibitor blend is present in the material at a range of 20-22% wt/wt.

7. The elastomeric material of claim 1, wherein the corrosion inhibitor blend is evenly spread throughout the elastomeric material.

8. The elastomeric material of claim 1, wherein the corrosion inhibitor blend bleeds out from the elastomeric material and polar bonds with the metal.

9. The elastomeric material of claim 8, wherein the corrosion inhibitor blend bleeds out from the elastomeric material and polar bonds with the metal at any thickness of the elastomeric material, whether the elastomeric material is compressed or relaxed.

10. The elastomeric material of claim 1, wherein the elastomeric material can be in a form of at least any one of a sheet gasket, a flange gasket, a ring gasket, a paper gasket, a cylinder head gasket, a molded gasket, an extruded gaskets and associated parts, a hose, a weather strip, a sealing system, a hydraulic wiper, a seal, a connector, a conveyor belt, a roll covering, a king post and windless base mount, a roofing sheet isolation packing, a window profile isolator and seal, a ship louvre mounted to bulkheads, a hatch mount mounted to bulkheads and marine compartments; a scupper lip, a ship scupper, a building scupper, tire and tube applications, electrical insulation and jacketing with medium to high dielectric strength, electrolysis isolation packing seals, and parts in storage or transport that are in wrapping films.

11. The elastomeric material of claim 1, further comprising reinforcing fillers, extending fillers, oils, stabilizers, curatives and other specially formulated corrosion inhibitor additives.

12. The elastomeric material of claim 1, further comprising a butyl layer on a surface of the elastomeric material, wherein the butyl layer comprises the corrosion inhibitor blend.

13. A method of making an elastomeric material comprising an elastomeric substance and a corrosion inhibitor blend, the method comprising:
mixing one or more corrosion inhibitors to form the corrosion inhibitor blend;
compounding the elastomeric substance; and
infusing of the corrosion inhibitor blend with the elastomeric substance during compounding to form a composite material; and
curing of the composite material to form the elastomeric material, wherein
the corrosion inhibitor blend is present in the elastomeric material at a range of 1-30% wt/wt,
the corrosion inhibitor blend polar bonds with a metal; and
the elastomeric material prevents corrosion of the metal through contact of the elastomeric material with the metal.

14. The method of making the elastomeric material of claim 13, wherein
the corrosion inhibitor blend comprises one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate, and
a percent of each corrosion inhibitor of the one or more corrosion inhibitors in the corrosion inhibitor blend is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 0-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the calcium dinonylnaphthalenesulfonate/carboxylate when present, or 1-25% for the zinc alkylnaphthalenesulfonate/carboxylate when present.

15. The method of claim 13, wherein the compounding and infusing of the corrosion inhibitor blend with the elastomeric substance further comprises adding any one or more of the following additives: reinforcing fillers, extending fillers, process oils, stabilizers, curatives and other specially formulated corrosion inhibitor additives.

16. The method of claim 13, further comprising calendaring of the elastomeric material with heated rollers comprising a one pass or multiple pass heated mixing, wherein:
the calendaring occurs during the compounding,
the corrosion inhibitor blend and additives are added during the calendaring,
the calendaring facilitates smoothing and compression of all ingredients of corrosion resistant material and preferably eliminates any dry/unwetted zones to eliminate uncurable areas of the corrosion resistant material infused with the corrosion inhibitor blend and other additives.

17. The method of claim 13, further comprising molding the elastomeric material comprising the corrosion inhibitor blend and the elastomeric substance into a gasket-like shape prior to curing; and
the curing comprises heating the composited material comprising the corrosion inhibitor blend and the elastomeric material.

18. A method of preventing corrosion of a metal comprising placing an elastomeric material in contact with the metal, wherein
the elastomeric material comprises an elastomeric substance and a corrosion inhibitor blend,
the corrosion inhibitor blend is present in the elastomeric material at a range of 1-30% wt/wt in the elastomeric material; and
the corrosion inhibitor blend bleeds out from the elastomeric material and polar bonds with the metal.

19. The method of preventing corrosion of claim 18, wherein the corrosion inhibitor blend comprises one or more corrosion inhibitors selected from the group consisting of, high-viscosity petroleum C20-50 hydrotreated neutral oil-based lubricating oils, bis(hydrogenated tallow alkyl)dimethyl quaternary ammonium salts with bentonite, hydrotreated heavy naphtha (petroleum), naphthalene sulfonic acid dinonyl-calcium salt, calcium carbonic acid, hydrotreated light petroleum distillates, Stoddard solvent, ethyl benzene, naphthalene, nonane, pseudocumene (1,2,4-trimethyl benzene), xylenes, carboxy-imidazoline mixture, barium carbonate, dinonylnaphthalenesulfonic acid, calcium dinonylnaphthalenesulfonate/carboxylate, or zinc alkylnaphthalenesulfonate/carboxylate; and
a percent of each corrosion inhibitor of the one or more corrosion inhibitors in the corrosion inhibitor blend is 25-75% for the bis(hydrogenated tallow alkyl)dimethyl quaternary ammonium salts with bentonite when present, 1-10% for the high-viscosity petroleum C20-50 hydrotreated neutral oil-based lubricating oils when present, 10-60% for the hydrotreated heavy naphtha (petroleum) when present, 5-35% for the naphthalene sulfonic acid dinonyl-calcium salt when present, 2-15% for the calcium carbonic acid when present, 1-15% for the hydrotreated light petroleum distillates when present, 0-40% for the Stoddard solvent when present, 0.01-1% for the ethyl benzene when present, 0.01-1% for the naphthalene when present, 0.1-1% for the nonane when present, 0.1-1% for the pseudocumene (1,2,4-trimethyl benzene) when present, and 0.1-1% for the xylenes when present, 5-15% for the carboxy-imidazoline mixture when present, 1-25% for the barium carbonate when present, 1-20% for the dinonylnaphthalenesulfonic acid when present, 1-30% for the calcium dinonylnaphthalenesulfonate/carboxylate when present, or 1-25% for the zinc alkylnaphthalenesulfonate/carboxylate when present.

20. The method of claim 18, wherein the elastomeric substance comprises at least one of a natural rubber, polyisoprene, butyl rubber, chloroprene rubber, ethylene propylene diene monomer (EPDM) rubber, fluorocarbon-based fluoroelastomer, fluorosilicone, nitrile butadiene rubber, saturated nitrile butadiene, silicone rubber (SI, gum, and liquid), styrene butadiene, urethane rubber, polyurethane, polyurea, open cell foam material, closed cell foam material, microcellular foams, and chemically cross-linked polyethylene foams.

21. The method of claim 20, wherein the elastomeric substance comprises ethylene propylene diene monomer (EPDM) rubber and the corrosion inhibitor blend is present in the elastomeric material at a range of 20-22% wt/wt.

22. The method of claim 18, wherein the placing of the elastomeric material is on a metal surface or between two metal surfaces, wherein each metal of the two metal surfaces is similar or dissimilar.

23. The method of claim 22, further comprising sealing of a gap between the two metal surfaces, wherein the sealing occurs from a coming together of the two metal surfaces and exerting compressive forces on the elastomeric material.
